(19) United States
(12) Patent Application Publication
(10) Pub. No.: US 2016/0335239 A1
(43) Pub. Date: Nov. 17, 2016

(54) INTELLIGENT SYSTEM AND METHOD OF COMPLETING A FORM USING A DEVICE

(71) Applicant: Union Pacific Railroad Company, Omaha, NE (US)

(72) Inventors: Jason Leonard Brown, Bellevue, NE (US); Benjamin Thomas Wisinski, Boulder, CO (US); Dianne McAndrew McGinn, Omaha, NE (US); Evan Reid Williams, Papillion, NE (US); Roy B. Rhee, Northbrook, IL (US)

(21) Appl. No.: 14/711,332

(22) Filed: May 13, 2015

(51) Int. Cl. G06F 17/24; G06F 3/0484; G06F 3/0488; H04M 1/02; H04L 29/08

(52) U.S. Cl. CPC G06F 17/243; H04M 1/0202; H04L 67/02; G06F 3/04886; G06F 3/04842

(57) ABSTRACT

Herein described are at least a device, a server, a computer readable storage media, and a method for filling out a user fillable document. For example, the method may include displaying an information request associated with an item description of the user fillable document in which the information request and an answer field are displayed in a first display area of the device. The method may further include displaying a portion of the user fillable document in a second display area of the device, in which the portion comprises the item description and a user editable field. In response to receiving an answer by the answer field, the method may further include displaying the answer in the user editable field of the second display area.

### BACKGROUND

Because of the limited display area provided by a wireless phone, the amount of information that is viewable may be less than desirable. For example, when filling out or completing a form (e.g., a job application form) using the wireless phone, a user may be unable to view the entire form because of the small display area. Typically, the user needs to scroll or navigate to each item in the form and provide an answer in an answer field. Scrolling to the appropriate location in the form may be time-consuming to the user. Furthermore, the user may need to magnify the text associated with an item to make it more readable. While doing so, a portion of the text associated with the item may become displaced outside of the viewable display area. As a consequence, the user may have difficulty reading the entire text associated with the item.

Thus, based on the foregoing shortcomings, it may be a difficult, tedious, and inefficient process for a user to fill out or complete a form using his wireless phone.

### SUMMARY

In light of the foregoing background, and other shortcomings, the following presents a simplified summary of the present disclosure in order to provide a basic understanding of some aspects described herein. This summary is not an extensive overview and is provided merely to introduce certain concepts, and is not intended to identify key or critical elements or to delineate the scope of the claims. The following summary merely presents some aspects in a simplified form as a prelude to the more detailed description that follows.

Various aspects of the disclosure provide at least a device, a server, a computer readable storage medium, and a method for filling out a document. Various aspects and representative embodiments of the device, the server, the computer readable storage medium, and the method are substantially shown in and/or described in connection with at least one of the following figures.

These and other advantages, aspects, and novel features of the present disclosure, as well as details of illustrated embodiments thereof, will be more fully understood from the following description and drawings.

### BRIEF DESCRIPTION OF THE DRAWINGS

Having thus described aspects of the disclosure in general terms, reference will now be made to the accompanying drawings in which some features are illustrated by way of example, which are not necessarily drawn to scale, and wherein:

FIG. 1A illustrates an example layout of a screen of a portable computing device in accordance with various embodiments.

FIG. 1B depicts an example view of a screen of a portable computing device in accordance with various embodiments.

FIG. 1C depicts an example view of a screen of a portable computing device in accordance with various embodiments.

FIG. 1D depicts an example view of a screen of a portable computing device in accordance with various embodiments.

FIG. 2 illustrates an example system environment in which various embodiments may be implemented.

FIG. 3 illustrates an example system block diagram of a portable computing device in which various embodiments may be implemented.

FIG. 4 illustrates an example system block diagram of a server, such as the server described in FIG. 2, in which various embodiments may be implemented.

FIGS. 5A, 5B, and 5C illustrate example operational flow diagrams of a method of filling out a user fillable document using a portable computing device in accordance with various embodiments.

FIGS. 6A, 6B, and 6C illustrate example operational flow diagrams of a method of filling out a user fillable document using a server and/or a portable computing device in accordance with various embodiments.

### DETAILED DESCRIPTION

In the following description of the various embodiments, reference is made to the accompanying drawings, which form a part hereof, and in which is shown by way of illustration the various embodiments in which aspects described herein may be practiced. It is to be understood that other embodiments may be utilized and structural and functional modifications may be made without departing from the scope and spirit of the present disclosure.

Described herein are at least a method and a system for electronically filling out a user fillable electronic form using a device. The device may comprise any type of computing device capable of processing data and displaying the user fillable electronic form. The computing device may comprise a wireless computing device and/or a wired computing device. The wireless computing device may communicate by way of wireless signals over an air interface while the wired computing device may communicate over wires by way of electrical signals. The wireless signals may be transmitted using one or more wireless communication protocols while the hardware connection may use one or more hardwired communication protocols. In one embodiment, the computing device may comprise a portable computing device. For example, the portable computing device may comprise a wireless device. The wireless device may comprise a wireless phone or mobile phone, wireless tablet, smartphone, wireless notepad or notebook, or wireless computer, for example. One or more display areas may be configured on the screen of the portable computing device. These one or more display areas may be used to electronically fill out the user fillable electronic form. Hereinafter, the viewable user fillable electronic form may be termed or referred to as a “user fillable document.” The user fillable document may comprise any type of electronic form, questionnaire, or application, or the like. The user fillable document may be stored as a file in a data storage device, such as a hard disk drive, optical drive, or magnetic drive, for example. The user fillable document may comprise a job application, an admissions application for an educational institution, an application for a license, a health or medical form, a customer service questionnaire, a survey, or a registration form, for example. While the various aspects of the disclosure hereinafter may describe features and/or elements associated with a portable computing device, these features and/or elements may be adapted to any type of computing device providing a display, including wireless, wired, and non-portable computing devices. It is intended that the disclosure not be limited to the particular embodiments disclosed.

Various aspects of the disclosure provide an efficient method for electronically filling out the user fillable document given that the portable computing device may provide a small or limited display area. The user fillable document may comprise a plurality of itemized fields which may need to be filled in or completed by a user of the portable computing device. Hereinafter, the one or more itemized fields in the user fillable document may be termed or referred to as one or more “user editable fields”. Each of the one or more user editable fields may be filled in, edited, and/or changed by the user. For example, a user may edit a user editable field after it has been populated with text. Each user editable field may be associated with an “item description” describing the information needed or required from the user. Information requests corresponding to the user editable fields may be sequentially generated and displayed to the user. For example, an information request may be generated when an unanswered user editable field is detected by the portable computing device. The various aspects of the disclosure may use a method that identifies and processes an item description associated with an unanswered, unpopulated, or blank user editable field. The identification of an item description corresponding to an unanswered user editable field may occur by way sequentially scanning the item descriptions that are detected in the user fillable document. For example, the user fillable document may be scanned from a left to right direction for each row of the user fillable document.

In accordance with the various aspects of this disclosure, one or more “information requests” may be displayed to the user of the portable computing device. An information request may comprise a question, a sentence, or a phrase associated with the item description, for example. The information request may be displayed to the user to assist the user in filling out the corresponding user editable field in the user fillable document. In response to the information request, the user may respond by inputting an answer into an “answer field” associated with the information request. The information request and its associated answer field may be displayed to a user by way of a first display area of the screen of the portable computing device. The corresponding user editable field may be populated after an answer is entered by the user into the answer field.

In accordance with the various aspects of this disclosure, a section or portion of a user fillable document may be displayed on the screen of a portable computing device. In one embodiment, the portion of the user fillable document displayed on the screen may correspond to a fraction or a subset of the user fillable document. The fraction or subset may comprise the entire user fillable document when the portable computing device comprises a wireless tablet or pad providing adequate screen area, for example. In accordance with an embodiment, the portion displayed on the screen may be automatically adjusted or appropriately sized to include only a single item description and its corresponding user editable field. In one embodiment, the portion displayed may comprise at least one item description displayed in its entirety and its corresponding user editable field. The screen may display the portion of the user fillable document comprising the item description and its user editable field in a second display area of the screen. The second display area may be scrollable or navigable so that the user may easily scroll or navigate to any portion of the user fillable document. The second display area may be adjacent to the first display area comprising the information request and answer field. In one embodiment, an appropriate portion of the user fillable document may be cropped or parsed from the user fillable document and displayed in the second display area. The appropriate portion may be determined based on the portion of the user fillable document being completed by the user.

In one embodiment, the second display area may comprise a graphical user interface configured to allow a user to scroll to any portion of the user fillable document. By way of scrolling, the user may use the graphical user interface to provide a view or display of any portion of the user fillable document. For example, by way of swiping the screen in a particular direction using his finger, the user may scroll to another area of the user fillable document corresponding to another item description and its corresponding user editable field. Furthermore, for example, the magnitude of the displacement in the particular direction may be a function of the velocity and/or strength of the finger swipe.

In one embodiment, the screen of the portable computing device may comprise a touch-screen. Touch-sensitive keys or a touch-sensitive keyboard may be provided in yet another display area of the screen. A third display area may be configured to provide a suitable or appropriate character set based on the information request formulated. The keyboard may correspond to the characters expected to be input by a user for a particular answer field. A user may input appropriate characters by way of the touch-sensitive keyboard or keypad provided by the portable computing device. The touch-sensitive keyboard may be used for inputting alpha-numeric characters into the answer field, for example. After data is entered into the answer field, the data may automatically populate the corresponding user editable field of the user fillable document.

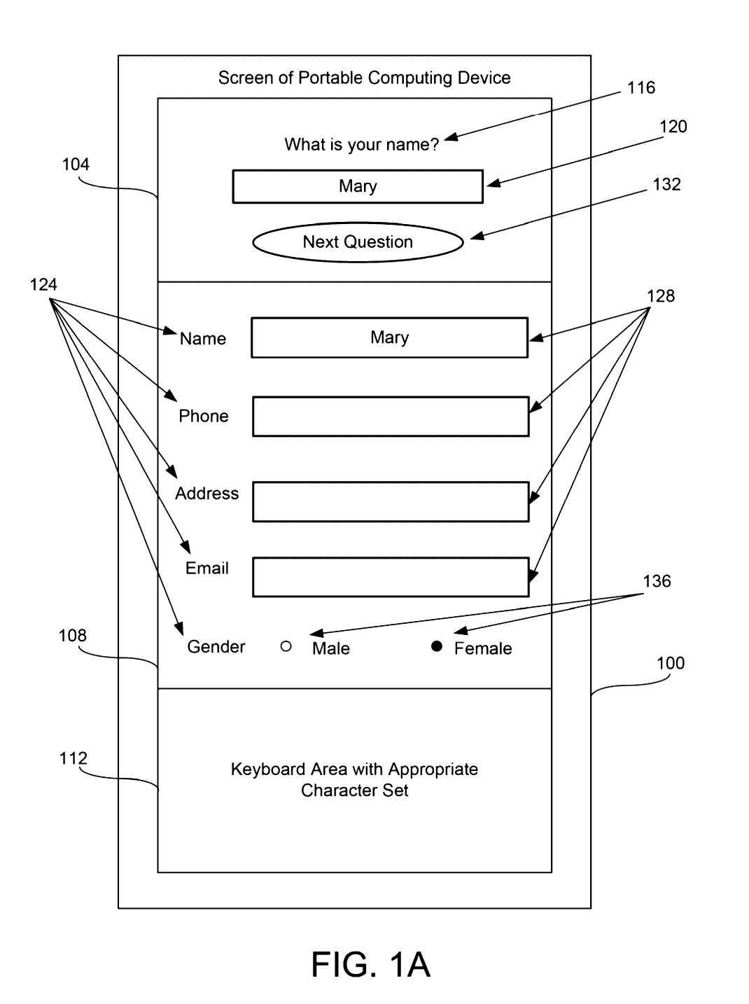

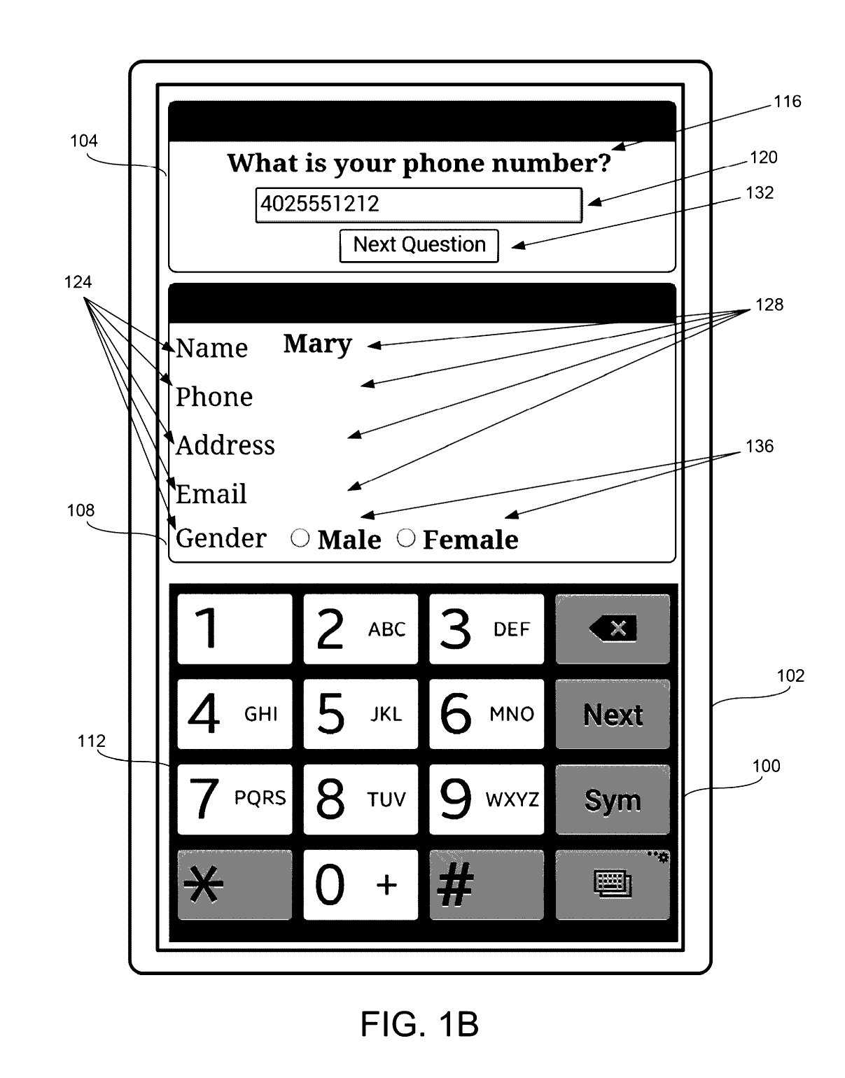

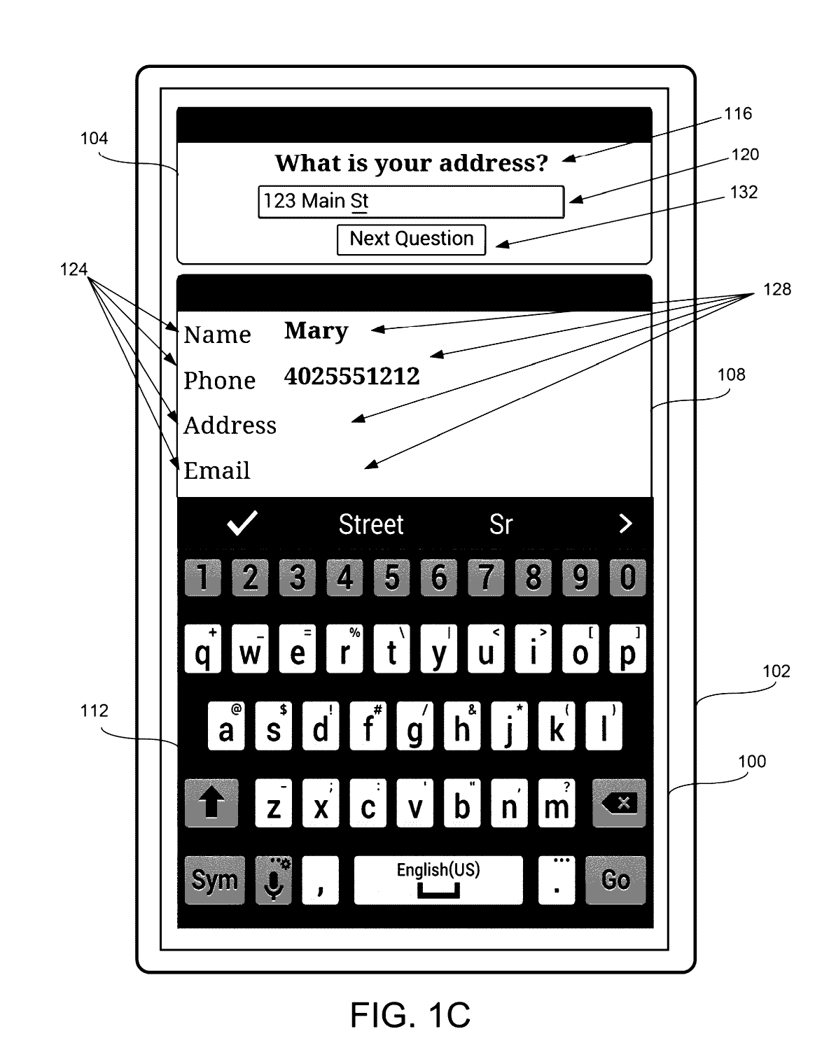

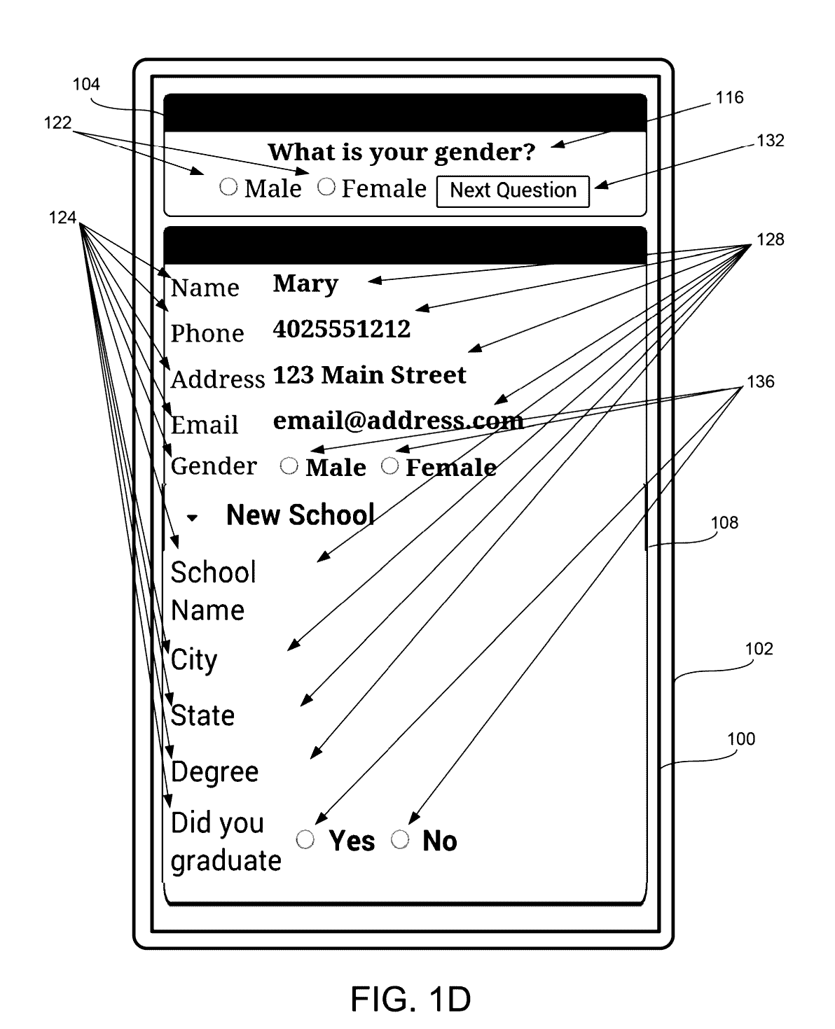

FIG. 1A illustrates an example layout of a screen 100 of a portable computing device in accordance with various embodiments. A screen or display device 100 may display one or more display areas. In the embodiment illustratively described in FIG. 1A, the screen or display device 100 comprises three display areas: a first display area 104, a second display area 108, and a third display area 112. Each of the display areas 104, 108, 112 may comprise a graphical user interface (GUI). The first display area 104 may be used to display one or more information requests 116 and its corresponding one or more answer fields 120. The illustrative embodiment of FIG. 1A depicts an example information request 116 (What is your name?) and a corresponding answer field 120 (containing the example answer, Mary). An information request 116 and its corresponding answer field 120 may be displayed to the user by way of the first display area 104. A portion of the user fillable document corresponding to the information request 116 and answer field 120 may be displayed to the user by way of the second display area 108. The second display area 108 may illustratively depict one or more item descriptions 124 and their corresponding one or more user editable fields 128. In addition to one or more user editable fields 128, the second display area may depict editable or selectable radio buttons 136. The example screen 100 illustratively describes example item descriptions 124 such as “Name”, “Phone”, “Address”, and “Email”. In this example, the user editable field associated with the item description, “Name”, has been populated with “Mary”. Each of the one or more user editable fields 128 may be automatically populated after text has been input by way of a user inputting text using an answer field 120. Text may appear in one of the user editable fields 128 when the next question button 132 is depressed or touched. Likewise, one of the radio buttons 136 may be automatically selected based on the answer provided by the user in the answer field 120. In the embodiment depicted in FIG. 1A, the portable computing device may automatically select or fill in the radio button for “female” based on the name (i.e., Mary) input by the user. A button, such as the “Next Question” button 132 illustratively depicted in the first display area 104, may be selected by the user to indicate that the user has finished inputting the answer into the answer field 120. The answer received by the answer field 120 may be displayed in one of the user editable fields 128 when the “Next Question” button 132 is depressed or touched. A keypad with a suitable character set may be displayed to the user by way of the third display area 112. The character set may comprise alphabetic text, numeric text, and/or alphanumeric characters in any language, for example. The character set chosen may depend on the data expected to be received by the answer field 120. Alternatively, in one embodiment, the answer field 120 may be replaced by one or more selectable radio buttons (as illustrated in FIG. 1D and subsequently described in connection with FIG. 1D).

FIG. 1B depicts an example view of a screen or display device 100 of a portable computing device 102 in accordance with various embodiments. The screen or display device 100 comprises a first display area 104, a second display area 108, and a third display area 112. The first display area 104 depicts an information request 116 and its corresponding answer field 120. The information request 116 in this example view comprises the question, “What is your phone number?” The answer field 120 contains the numbers “4025551212”. A button 132 may be depressed or touched by the user to indicate that the user has finished inputting the answer into the answer field 120. The second display area 108 depicts one or more item descriptions 124 and their corresponding user editable fields 128. In this example view, the item description 124 corresponding to “Name” has a user editable field 128 that is populated with “Mary”. The second display area 108 further depicts editable or selectable radio buttons 136. The third display area 112 depicts a numeric keypad to allow a user to input the appropriate numbers into the answer field 120. The keypad may automatically display an appropriate character set to the user based on the data expected to be received by an answer field.

FIG. 1C depicts an example view of a screen or display device 100 of a portable computing device 102 in accordance with various embodiments. The screen or display device 100 comprises a first display area 104, a second display area 108, and a third display area 112. The first display area 104 depicts an information request 116 and its corresponding answer field 120. The information request 116 in this example view comprises the question, “What is your address?” The answer field 120 contains the characters “123 Main St”. A button 132 may be depressed or touched by the user to indicate that the user has finished inputting the answer into the answer field 120. The second display area 108 depicts one or more item descriptions 124 and their corresponding user editable fields 128. In this example view, the item description 124 corresponding to “Name” has a user editable field 128 that is populated with “Mary” and the item description 124 corresponding to “Phone” has a user editable field 128 that is populated with “4025551212”. The third display area 112 depicts an alphanumeric keypad to allow a user to input the appropriate alphanumeric characters into the answer field 120. As depicted in FIG. 1C, a portion of the third display area 112 may provide a word selection feature that provides word choices based on inputs provided by the user. The user may make an appropriate word selection based on the available word choices provided by the portable computing device by way of depressing or touching the appropriate word choice.

FIG. 1D depicts an example view of a screen or display device 100 of a portable computing device 102 in accordance with various embodiments. The screen or display device 100 comprises a first display area 104 and a second display area 108. The first display area 104 depicts an information request 116 and a plurality of radio buttons 122. The information request 116 in this example view comprises the question, “What is your gender?” An answer may be selected by selecting the one or more radio buttons 122. In this embodiment, the first display area 104 depicts two radio buttons 122 (associated with “Male” and “Female”). After a selection is made, a button 132 may be depressed or touched by a user of the example portable computing device 102 to indicate that the user has selected one of the radio buttons 122. When one of the radio buttons 122 is selected by the user, the corresponding radio button 136 may be automatically selected in the second display area 108. The second display area 108 depicts one or more item descriptions 124 and their corresponding user editable fields 128. In this example view, the item description 124 corresponding to “Name” is associated with a user editable field 128 that is populated with “Mary” while the item description 124 corresponding to “Phone” is associated with a user editable field 128 that is populated with “4025551212”. The item description 124 corresponding to “Address” is associated with a user editable field 128 that is populated with “123 Main Street” while the item description 124 corresponding to “Email” is associated with a user editable field 128 that is populated with “email@address.com”. The contents of each of these user editable fields 128 may be modified or revised by the user, such as for example, when an error or typo has been made by the user while inputting data into an answer field. As shown in FIG. 1D, the second display area may depict radio buttons 136. The user may edit or change a previously made selection by selecting or de-selecting one of the radio buttons 136. The illustrative embodiment shown in FIG. 1D does not depict a keyboard because a selection is made using the plurality of radio buttons 122. In this example view, the second display area 108 displays a portion of the user fillable document that includes a plurality of item descriptions 124, corresponding user editable fields 128, and a plurality of selectable radio buttons 136.

Each of FIGS. 1A, 1B, 1C, and 1D illustratively describes an example layout and it is contemplated that other spatial arrangements of the first, second, and third display areas may exist in other embodiments. For example, the order or locations of the first, second, and third display areas may be rearranged in any desired manner on the screen or display device 100.

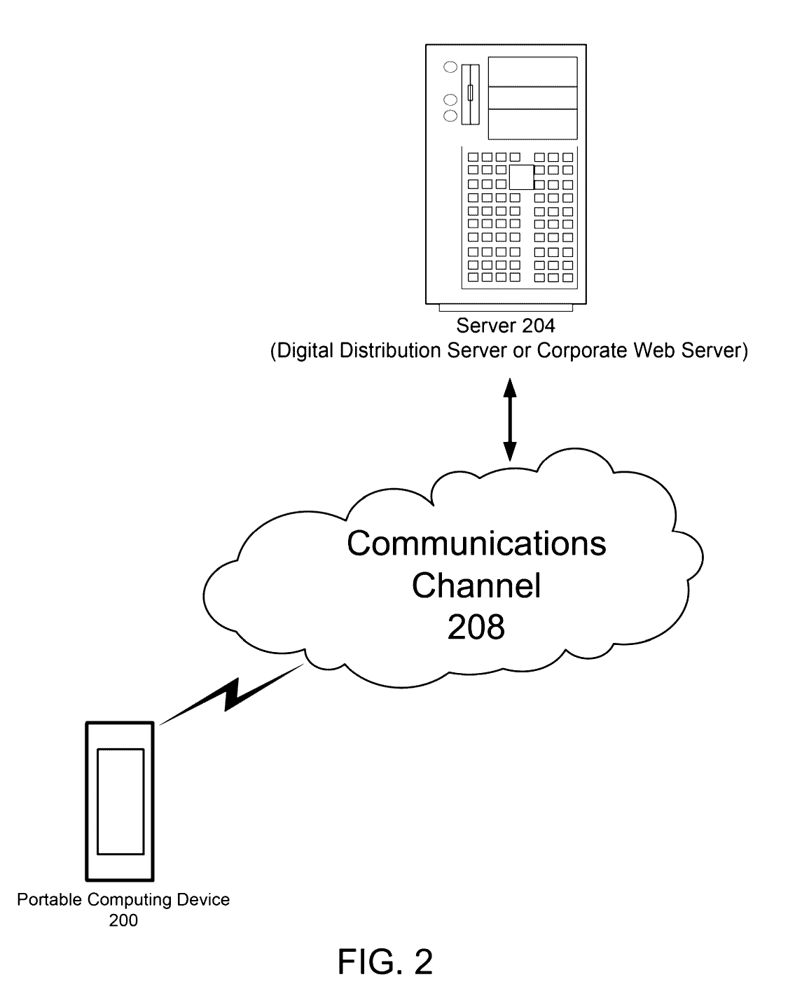

FIG. 2 illustrates an example system environment in which various embodiments may be implemented. The system environment depicted in FIG. 2 is only one example of a suitable system environment and is not intended to suggest any limitation as to the scope of use or functionality contained in this disclosure. The system environment may comprise a portable computing device 200 and a server 204, for example. While the embodiment depicted in FIG. 2 illustratively describes a single server 204, the single server may represent a plurality of servers communicatively coupled together. The server 204 may be communicatively coupled to the portable computing device 200 by way of a data communications network such as a communications channel 208. The communications channel 208 may comprise one or more telecommunications links, such as, for example, one or more cellular, Internet, microwave, and fiber optic links, for example. The portable computing device 200 may comprise a mobile phone, a smartphone, or a tablet (or pad), for example. The portable computing device 200 may comprise a screen, such as the screen previously described in connection with FIGS. 1A, 1B, 1C, and 1D. In one embodiment, the portable computing device 200 may comprise a touch-sensitive screen that may provide an input/output communication interface for the user. The screen may comprise an LCD, OLED, AMOLED type of screen, for example. In another embodiment, the portable computing device 200 may comprise a physical keyboard, such as a QWERTY keyboard.

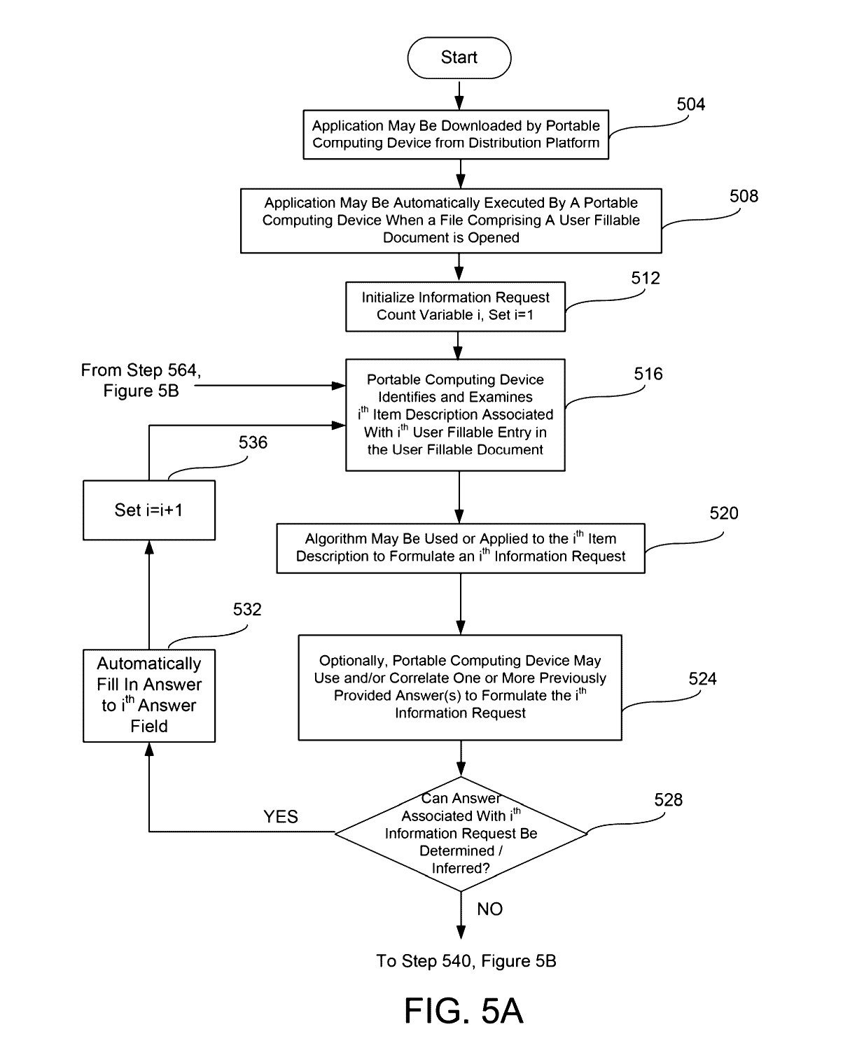

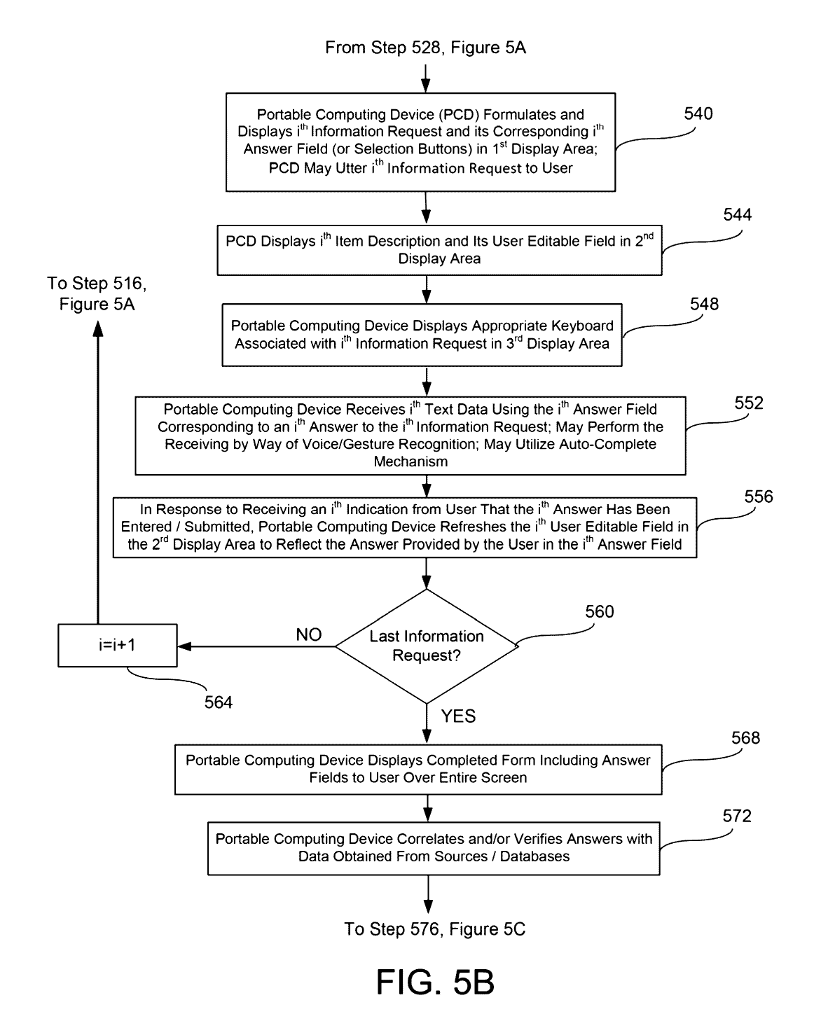

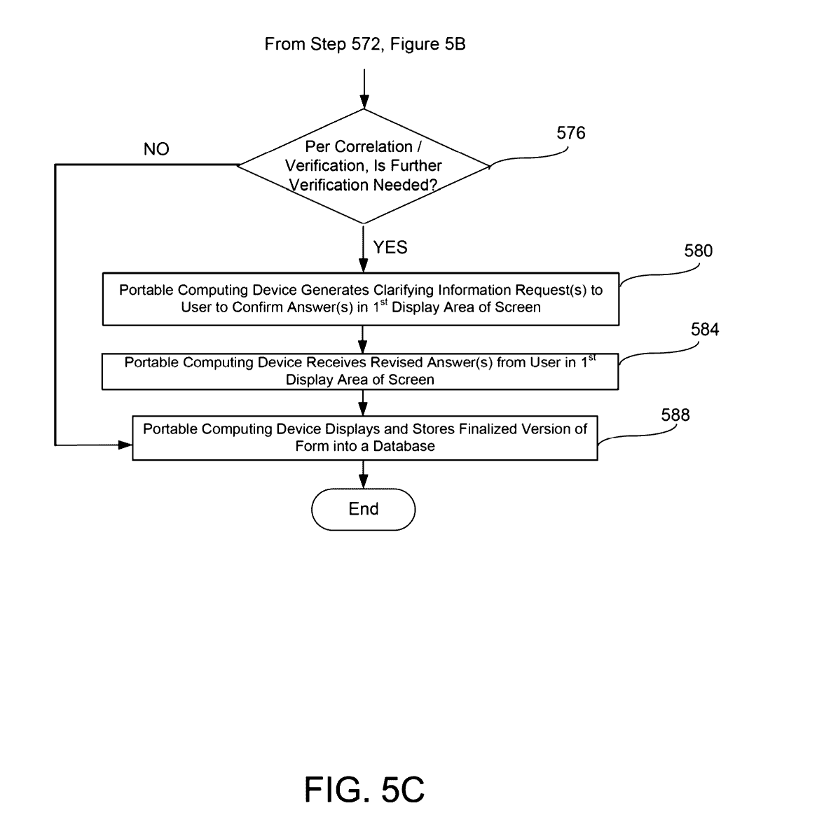

In one embodiment, the server 204 may comprise a digital distribution platform for transmitting and distributing a software application to the portable computing device 200. The digital distribution platform may store the software application in a data storage device such as a hard disk drive, for example. The software application may be compatible with the operating system of the portable computing device 200. The digital distribution platform may comprise any type of platform for distributing software applications to one or more portable computing devices, such as Google Play® or Apple Inc.'s App Store™, for example. The software application may be downloaded from the digital distribution platform by way of a command executed by a user of the portable computing device 200. The software application may be downloaded from the digital distribution platform when the platform recognizes that one or more user Tillable documents are stored or being used by the portable computing device 200. The software application may be downloaded automatically by the portable computing device 200 from the digital distribution platform. After the software application has been downloaded into the portable computing device 200, the software application may be run or executed automatically or by way of a command provided by the user. For example, the software application may be executed automatically when a user fillable document is opened and viewed by a user of the portable computing device 200. The software application may be executed by a processor of the portable computing device 200. In one embodiment, upon execution of the software application, one or more processes for allowing a user to electronically fill out the user fillable document, using a portable computing device 200, may be transparent to the user and running in the background of the portable computing device. The one or more processes may be performed when a user fillable document is opened for display by the portable computing device 200. In one embodiment, the one or more processes depicted in connection with FIGS. 5A, 5B, and 5C may be performed by the portable computing device 200.

In one embodiment, the aforementioned software application may be resident in a memory of the portable computing device 200. The software application may be incorporated into the portable computing device 200 before the portable computing device 200 is packaged and sold to the public. Therefore, the portable computing device 200 may include the software application when it is issued to the user. For example, a wireless carrier or portable communication device manufacturer may provide a portable communication device 200 containing the software application previously described.

In one embodiment, the server 204 may comprise a corporate web server, for example. The portable computing device 200 may communicate with the corporate web server to initiate the process of efficiently filling out a form, questionnaire, or application in accordance with various aspects of the present disclosure. The portable computing device 200 may initiate the process by way of opening a file comprising the user fillable document. The file may be provided by the corporate web server. The corporate web server may sequentially transmit an information request and its corresponding answer field for display at the portable computing device 200. The corporate web server may transmit corresponding one or more portions of the user fillable document for display at the portable computing device 200. The file comprising the user fillable document may be opened, accessed, and/or downloaded by way of a user depressing or touching a link provided by a webpage hosted by the corporate web server.

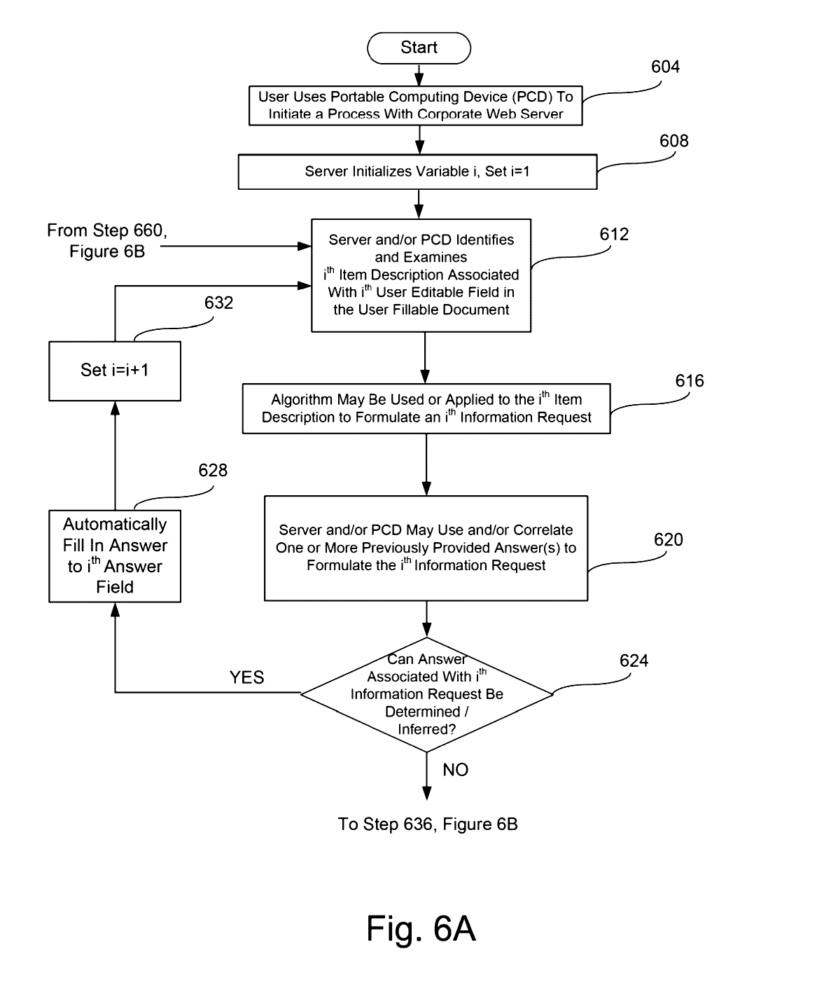

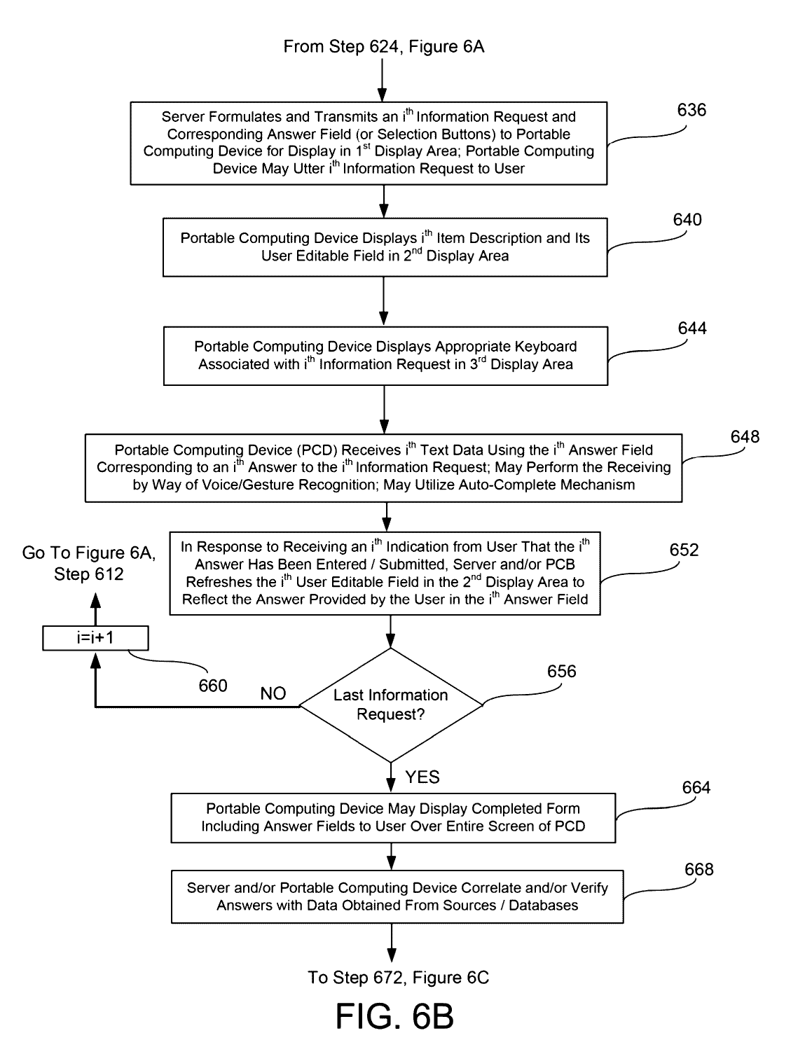

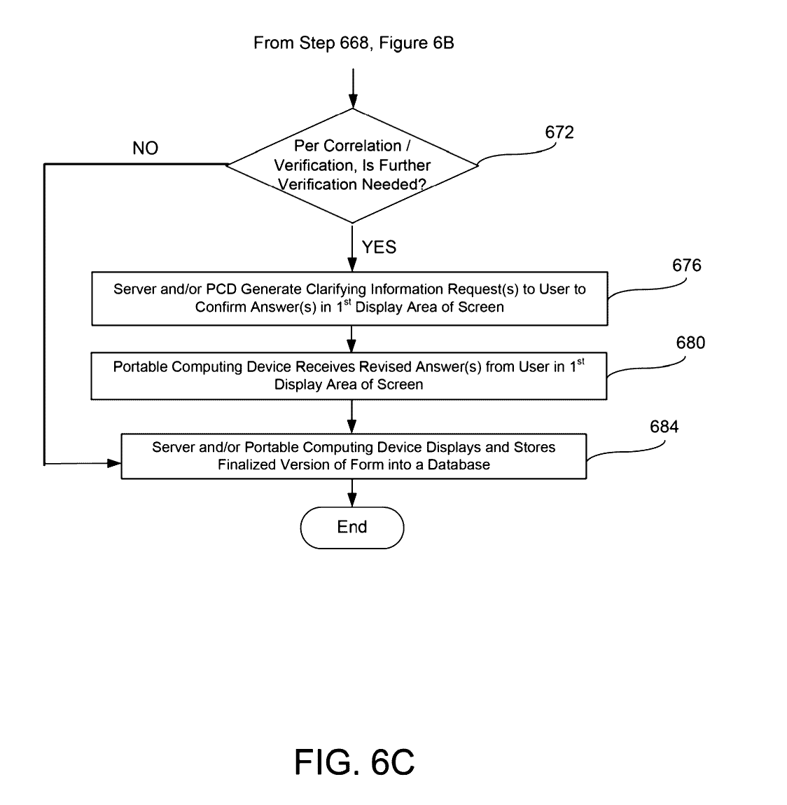

In one embodiment, opening, accessing, and/or downloading the file may cause a processor resident in the corporate web server to execute a software application. Execution of the software application may initiate one or more processes described in accordance with the various aspects of the disclosure. In an embodiment, the one or more processes depicted in connection with FIGS. 6A, 6B, and 6C may be performed by the server 204 and the portable computing device 200.

A portion or subset of the user fillable document may be identified and transmitted to the portable computing device 200 by the corporate web server. In one embodiment, a portion of the user fillable document may be identified and parsed by way of execution of a software application resident in a memory or data storage device of the corporate web server. The software application may execute an algorithm that facilitates the transmission of one or more signals, such as commands and/or data, to the portable computing device 200, which are used in displaying the portion or subset of the user fillable document. The one or more signals may be transmitted to in response to one or more signals received by the server from the portable computing device 200. The commands provided by the server may instruct how the data associated with the portion or subset is displayed on the screen of the portable computing device 200. The commands may provide spatial or positional information for how the portion or subset is to be displayed on the screen. The commands and data provided by the server may determine the text and/or graphics that are displayed on the portable computing device 200. The portion may be transmitted to the portable computing device 200 at approximately the time when the corresponding information request and its answer field are transmitted. In one example, a portion of the user fillable document may comprise the entire user fillable document. In another example, the portion or subset may be defined as a subset or fraction of the user fillable document that includes an entire item description and its corresponding user editable field. In another example, the portion or subset may be defined as a fraction of the user fillable document that includes a subset of the entire item description and its corresponding user editable field. The portion or subset of the user fillable document that is transmitted to the portable computing device for display may be determined, for example, based on the size of the associated display area, size of the screen provided by the portable computing device 200, and/or resolution of the screen of the portable computing device 200. In addition, the portion or subset of the user fillable document that is transmitted to the portable computing device may be based on the amount or size of text associated with the information request to be displayed.

In the instance where the server 204 comprises the digital distribution platform or the corporate web server, the software application may be configured to facilitate displaying a portion of the user fillable document in a display area on the screen of the portable computing device 200. The display area may comprise a user editable field which may be used by the user to correct or modify the information or answer previously provided by the user responding to an information request. The answer may be modified by the user by way of positioning a cursor in the user editable field and editing the appropriate text. The user may adjust the portion of the user fillable document displayed on the screen of the portable computing device 200 by way of a zoom, enlarge, or magnify feature. The portion may be zoomed in or zoomed out based on the preferences of the user. For example, the portion of the user fillable document may be appropriately sized, based on one or more of: a) the size and amount of the text associated with the item description for a particular user editable field, b) the size of the display area apportioned for displaying the portion of the user fillable document, and c) the dimensions and/or resolution of the screen.

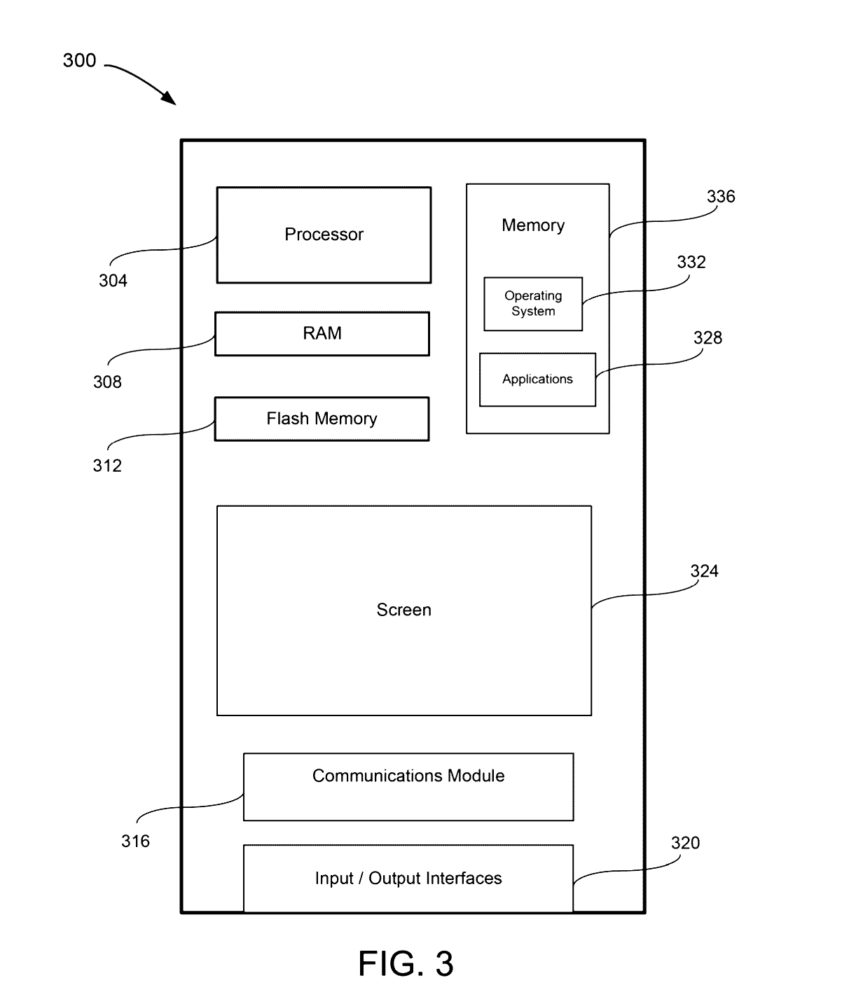

FIG. 3 illustrates an example system block diagram of a portable computing device 300 in which various embodiments may be implemented. The portable computing device 300 may comprise a processor 304, a random access memory (RAM) 308, a flash memory 312, a communications module 316, input/output interfaces 320, a memory 336, and a display device or screen 324. The memory 336 may be used to store an operating system (OS) 332 and one or more applications or software applications 328. The memory 336 may comprise non-volatile memory such as read only memory (ROM). The ROM may be used to store the operating system (OS) 332 and firmware associated with the portable computing device 300. The portable computing device 300 may comprise a processor 304 for executing computer executable instructions or instructional code associated with the one or more applications 328. The random access memory (RAM) 308 may store data used by the processor 304 while executing the instructional code. When the instructional code is executed by the processor 304, the one or more method steps described in FIGS. 5A, 5B, and 5C may be performed. The communications module 316 may be used for communicating to another device. The communications module 316 may comprise a wireless modem used for transmitting data to and receiving data from a cellular tower, for example. The communications module 316, for example, may comprise a wireless adapter and/or wireless interface to allow wireless communication to occur between the portable computing device 300 and a server, such as the server previously described in connection with FIG. 2. The portable computing device 300 further comprises input/output interfaces 320 for receiving commands from a user and for generating sounds back to the user. The commands may comprise audio and/or visual commands. An input interface may comprise a keyboard for inputting text, a camera for receiving visual commands, and/or a microphone for receiving sounds or audible commands. The keyboard may comprise a displayable touch sensitive LCD or LED keyboard. The microphone may be used to receive an answer to an audible command such as an information request. The answer may be uttered by a user and may be automatically processed and displayed in the answer field. An output interface may comprise a speaker for generating tones or audible messages from the portable computing device 300 to the user. The screen 324 may be used for providing visual information to the user. In accordance with various aspects of the disclosure, the screen 324 may be divided into at least two display areas. In one embodiment, the at least two display areas comprise at least a first graphical user interface (first GUI) and a second graphical user interface (second GUI). In one embodiment, the first display area may be used to sequentially display each of one or more information request(s) (e.g, questions directed to the user) formulated by the portable computing device 300. In another embodiment, the first display area may be used to sequentially display each of one or more questions formulated by the server. Yet, in another embodiment, the first display area may be used to sequentially display each of one or more questions formulated by the server and the portable computing device 300. In one or more of these embodiments, a corresponding answer field may be provided for each of the one or more information requests to allow a user to provide an answer. In any of these embodiments, the second display may be used to display a portion or subset of a user fillable document corresponding to a portion of the form, questionnaire, or application. The portion or subset displayed by the second display area may comprise the item description and user editable field corresponding to the information request displayed in the first display area. The user fillable document may be formatted in PDF or HTML, for example.

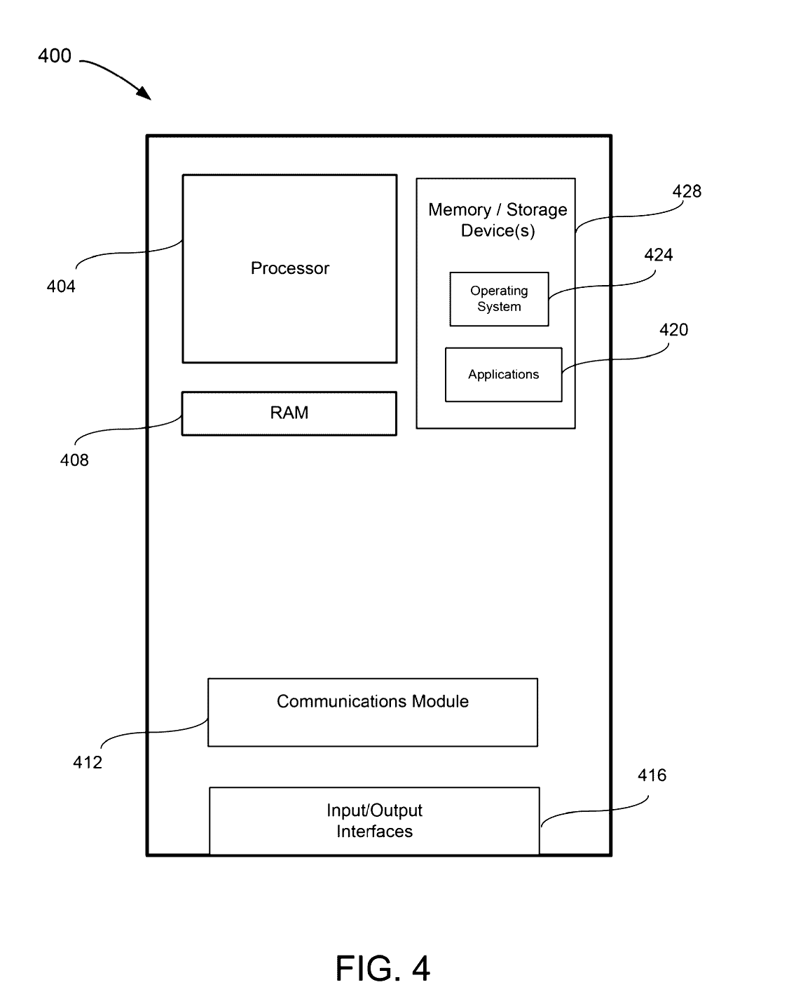

FIG. 4 illustrates an example system block diagram of a server 400, such as the server 204 described in FIG. 2, in which various embodiments may be implemented. The server 400 may be implemented using any type of computing device such as a personal computer, laptop, desktop, mainframe computer, for example. The server 400 may comprise a digital distribution platform or a corporate web server, as was previously described in connection with FIG. 2. The server 400 may comprise memory/data storage device(s) 428 for storing data such as the server's operating system (OS) 424 and one or more applications or software applications 420. The operating system (OS) 424 may be used to internally control self-contained devices such as graphics cards, hard disk drives, optical drives, and the like. The memory/storage device(s) 428 may comprise one or more hard disk drives, optical drives, and/or non-volatile memory such as read only memory (ROM) or flash memory, for example. The server 400 may comprise a processor 404 for executing computer executable instructions or instructional code associated with the one or more applications 420. The random access memory (RAM) 408 may store data used by the processor 404 while executing the instructional code. When the instructional code is executed by the processor 404, the one or more method steps described in FIGS. 6A, 6B, and 6C may be performed by the server 400 and/or the portable computing device 300. The server 400 further comprises a communication module 412 used for communicating with the portable computing device 200, 300 previously described in connection with FIGS. 2 and 3. The communication module 412 may comprise an Ethernet network or wireless adapter for transmitting to and receiving data from a networking device such as a switch, access point, or router, for example. The server 400 further comprises input/output interfaces 416 for receiving data provided by a user and for communicating data to the user. The input interface 416 may comprise a keyboard, camera, and/or a microphone for receiving data and visual and/or audible commands from the user. The output interface 416 may comprise one or more connections for communicating to a display monitor for providing video and/or to a speaker for generating tones or audible messages to a user.

In other embodiments, the server 400 may be substituted or replaced with a plurality of servers communicatively coupled together to implement a distributed processing system environment. The server 400 may comprise any type of computing system. The server 400 may comprise any type of computing device, such as a personal computer (PC), minicomputer, multiprocessor system, microprocessor-based system, set-top box, programmable consumer electronics, hand-held or laptop computing device, network computer, mainframe computer, and the like, or a combination thereof communicatively coupled together.

In one embodiment, the portable computing device 300 and/or the server 400 may process a document file using one or more applications. The one or more applications may be executed by one or more processors of the portable computing device 300 and/or the server 400, causing one or more information requests to be formulated and delivered to the user. The one or more information requests may be formulated based on one or more expected answers associated with the user fillable document. The one or more questions may be formulated and stored in memory 336, 428 of the portable computing device 300 and/or the server 400. The one or more questions may be formulated based on previously answered questions provided by the user of the portable computing device 300. Each of the one or more questions may be sequentially displayed by the portable computing device 300 until the last answer has been submitted by the user.

FIGS. 5A, 5B, and 5C illustrate example operational flow diagrams of a method of filling out a user fillable document using a portable computing device in accordance with various embodiments. The portable computing device 200, 300 was illustratively described in connection with FIGS. 2 and 3. At step 504, a software or software application may be downloaded from a digital distribution platform such as the server 204 previously described in connection with FIG. 2. In one embodiment, the software application may be downloaded from the digital distribution platform by way of a command executed by a user of the portable computing device as was previously described in connection with FIGS. 2 and 3. In another embodiment, the software application may be incorporated into the portable computing device before the portable computing device is sold to a user. The software application may be supplied or provided by any entity that uses or desires to use electronic forms to obtain information from a user of a portable computing device. For example, the entity may comprise a company that provides a job application form or a college that provides an admission application form. At step 508, the software application may be manually or automatically executed by a processor or processing module of the portable computing device. The processor may comprise the processor 304 previously described and shown in FIG. 3. As previously described in connection with FIG. 3, the software application may be stored in memory of the portable computing device. The software application may be executed when a file is accessed and/or opened. The processor of the portable computing device may execute computer executable instructions or instructional code associated with the software application. When executed, the software application may perform the sequence of steps starting from step 512 thereon. The file may comprise any user fillable document such as any type of electronic form, questionnaire, or application, or the like. At step 512, an information request count variable, i, may be initialized by way of setting i to the value 1. The information request count variable may be used to index and identify the i^{th} item description and its corresponding i^{th} user editable field in the user fillable document. Thereafter, at step 516, the portable computing device may identify and examine the i^{th} item description associated with the i^{th} user editable field in the user fillable document. The portable computing device may assign a count value to each item description and its corresponding user editable field in the user fillable document. By way of assigning a count value to each item description and its user editable field, the portable computing device may be able to index each item description and its corresponding user editable field in the user fillable document. At step 520, an algorithm may be used to recognize the text in the i^{th} item description and formulate an i^{th} information request based on the i^{th} item description. The algorithm may run when the processor 304 executes the computer executable instructions associated with the software application. The i^{th} information request may comprise a question directed to the user of the portable computing device. In response to the i^{th} information request, the user may provide an answer for the corresponding answer field. The i^{th} information request and answer field may be displayed in a first display area of the screen of the portable computing device. An i^{th} item description (corresponding to the i^{th} information request) and its corresponding i^{th} user editable field may be displayed in a second display area. Next, at step 524, the portable computing device may use and/or correlate one or more answers that were previously provided by the user with the i^{th} item description to formulate the i^{th} information request. In one embodiment, the previously provided answers may be used to determine whether the i^{th} information request is redundant or unnecessary. The one or more previously provided answers may also be correlated with data obtained from a database and/or the Internet, for example, to determine whether the i^{th} proposed information request is redundant or unnecessary. The process continues at step 528 where a decision is made whether the answer associated with the i^{th} information request can be determined or inferred based on the one or more previously provided answers. If the answer associated with the i^{th} information request can be determined or inferred, the process continues with step 532. Otherwise, the process continues with step 540 at FIG. 5B. At step 532, based on the correlation, the portable computing device may automatically fill in or populate the appropriate answer into the i^{th} answer field. For example, when the item description indicates a request for gender or sex and the corresponding information request comprises “What is your gender?” the portable computing device may deduce that the user is female if a previous answer received from the user is “Mary”. Thereafter, at step 536, the count variable may be incremented by one and the process reverts back to step 516.

If the process proceeds with step 540, the portable computing device may formulate and display the i^{th} information request and its corresponding i^{th} answer field. A processor or processing module of the portable computing device may execute instructions to effectuate identification of the i^{th} item description and formulation of the i^{th} information request. The process of formulating the i^{th} information request may comprise locating the i^{th} item description in the user fillable document, identifying the text associated with the i^{th} item description, and processing the text to formulate the i^{th} information request. The i^{th} information request may be presented in the form of a question to the user. In one embodiment, the corresponding i^{th} answer field may be replaced with one or more selections or choices. The one or more selections may comprise one or more radio buttons, for example, which may be easily selected by the user, for example. In one embodiment, the portable computing device may utter the i^{th} information request and/or the one or more selections or choices to the user. At step 544, the portable computing device may display the i^{th} item description and its corresponding i^{th} user editable field in the second display area. The second display area may be automatically adjusted to include the i^{th} item tem description and its corresponding user editable field. At step 548, the portable computing device may provide a displayable keyboard or keypad to the user by which the user may input data. The appropriate keyboard may be automatically generated in a third display area and may provide an appropriate character set required for a user to answer the i^{th} information request. In one embodiment, the keyboard may comprise a touch sensitive or touch screen keypad displayed over the third display area. In one embodiment, the third display area may be automatically displayed when a cursor is placed within the i^{th} answer field. In another embodiment, the keyboard may comprise a physical keyboard of the portable computing device. Next, at step 552, the portable computing device may receive data corresponding to the i^{th} answer of the i^{th} information request.

In one embodiment, the answer may be received when the user utters words captured by a microphone. The received audio may be processed by way of a voice recognition algorithm executed by a processor in the portable computing device. In one embodiment, the user may provide one or more gestures to an integrated camera of the portable computing device. The one or more gestures may be used to indicate a selection of one or more selections. The one or more gestures may comprise one or more movements performed by the user, such as hand or fingertip signs, signals, and/or motions. The received video may be processed by way of a gesture recognition algorithm executed by the processor of the portable computing device. In one embodiment, the portable computing device may assist the user by way of an auto-complete mechanism, allowing the user to select a desired word or phrase as the user types. Thereafter, at step 556, the user may provide an indication that the i^{th} answer has been fully entered or submitted. In response to receiving an indication from the user that the answer has been fully entered or submitted, the portable computing device may automatically refresh the corresponding user editable field located in the second display area to reflect the answer provided by the user in the i^{th} answer field. The user may view the contents in any of the user editable fields of the user fillable document by way of scrolling to the desired user editable field in the user fillable document. The user may edit any user editable field if there is a need to do so. Thereafter, the process proceeds with step 560 where a decision is made whether the i^{th} information request comprises the last information request. If the i^{th} information request corresponds to the last information request in the user fillable document, the process continues at step 568. Otherwise, the process continues at step 564 where the count variable is incremented by one. Thereafter, the process reverts back to step 516. At step 568, the portable computing device may display the entire completed user fillable document to the user. Next, at step 572, the portable computing device may correlate and/or verify each of the one or more answers provided by the user with data obtained from other sources and/or databases. One of the other sources may comprise the Internet.

If the correlation and/or verification determine that an answer provided by the user is not consistent with what is found from the other sources and/or databases, further verification and/or confirmation may be needed. An answer may be correlated with one or more databases and the outcome of the correlation may comprise a value. At step 576, a decision may be made whether further verification is needed based on the outcome of the correlation and/or verification. When the outcome comprises a value, further verification may be performed if the value falls below a particular confidence level. If it is determined that further verification is required based on the value, the portable computing device, at step 580, may generate one or more clarifying information requests to the user in an attempt to confirm an answer received by the user. The one or more clarifying information requests may be presented to the user in the first display area, for example. The one or more clarifying information requests may comprise one or more questions that confirm the i^{th} answer. Thereafter, at step 584, the portable computing device may receive a revised answer in response to the one or more clarifying information requests. Thereafter, at step 588, after each of the answers provided by the user has been correlated and verified, the portable computing device may display the finalized version of the user fillable document to the user and store the finalized version of the user fillable document into a database. The database and the user fillable document may be stored in a server and/or the portable computing device.

FIGS. 6A, 6B, and 6C illustrate example operational flow diagrams of a method of filling out a user fillable document using a server and/or a portable computing device in accordance with various embodiments. The server 204, 400 and the portable computing device 200, 300 were illustratively described in connection with FIGS. 2, 3 and 4. At step 604, a user may utilize his portable computing device to initiate a process of filling out the user fillable document. The user fillable document may be accessed from a server such as a corporate web server or another server by way of using the portable computing device. The user fillable document may comprise a file which may be opened, accessed, and/or downloaded by way of the user depressing or touching a link provided by a webpage hosted by the server using his portable computing device. In one embodiment, opening, accessing, and/or downloading the file from the server may cause a processor or processing module resident in the corporate web server to execute a software application. The processor may comprise the processor 404 previously described and shown in FIG. 4. As previously described in connection with FIG. 4, the software application may be stored in memory/data storage device(s) of the server. In one embodiment, downloading the file by a portable computing device may initiate execution of the software application. The software application may be executed when the file is accessed and/or opened. A processor of the server may execute computer executable instructions or instructional code associated with the software application. When executed, the software application may perform the sequence of steps starting from step 608 thereon. At step 608, an information request count variable, i, may be initialized by way of setting i to the value 1. The information request count variable may be used to index and identify the i^{th} item description and its corresponding i^{th} user editable field in the user fillable document. Next, at step 612, the server and/or portable computing device may identify and examine the i^{th} item description associated with the i^{th} user editable field in the user fillable document. The server and/or portable computing device may assign a count value to each item description and its corresponding user editable field in the user fillable document. By way of assigning a count value to each item description and its user editable field, the server and/or portable computing device may be able to index each item description and its corresponding user editable field in the user fillable document. At step 616, an algorithm may be used to recognize the text in the i^{th} item description and formulate an i^{th} information request based on the i^{th} item description. In one embodiment, the algorithm may run when the processor 404 executes the computer executable instructions associated with the software application. In another embodiment, the algorithm may run when both the processor 404 of the server 400 and the processor 304 of the portable computing device 300 execute the computer executable instructions that may be associated with the executed software application. The i^{th} information request may comprise a question directed to the user of the portable computing device to elicit an answer corresponding to the i^{th} item description. In response to the i^{th} information request, the user may provide an answer into the corresponding answer field. The i^{th} information request and answer field may be displayed in a first display area of the screen of the portable computing device. An i^{th} item description (corresponding to the i^{th} information request) and its corresponding i^{th} user editable field may be displayed in a second display area. Thereafter, at step 620, the server and/or portable computing device may use and/or correlate one or more answers that were previously provided by the user with the i^{th} item description to formulate the i^{th} information request. In one embodiment, the previously provided answers may be used to determine whether the i^{th} information request is redundant or unnecessary. The one or more previously provided answers may also be correlated with data obtained from a database and/or the Internet to determine whether the i^{th} information request is redundant or unnecessary. The process continues at step 624 where a decision is made whether the answer associated with the i^{th} information request can be determined or inferred based on the one or more previously provided answers. If the answer associated with the i^{th} information request can be determined or inferred, the process continues with step 628. Otherwise the process continues with step 636 at FIG. 6B. At step 628, based on the correlation, the server and/or portable computing device may automatically fill in or populate the appropriate answer into the i^{th} answer field. The server may transmit the appropriate answer to the portable computing device so that the portable computing device may display the answer in the answer field and/or the user editable field. For example, when the information request comprises “What is your gender?” the server may deduce that the user is female if a previous answer received from the user is “Mary”. Thereafter, at step 632, the count variable may be incremented by one and the process reverts back to step 612.

If the process proceeds with step 636, the server may formulate and transmit an i^{th} information request and its corresponding answer field to the portable computing device for display in a first display area. A processor of the server may execute instructions to effectuate identification of the i^{th} item description and formulation of the i^{th} information request. The process of formulating the i^{th} information request may comprise locating the i^{th} item description in the user fillable document, identifying the text associated with the i^{th} item description, and processing the text to formulate the i^{th} information request. The server may transmit the i^{th} information request and its corresponding i^{th} answer field by way of transmitting one or more commands and/or data to the portable computing device. The i^{th} information request may be presented in the form of a question to the user. In one embodiment, the corresponding i^{th} answer field may be replaced with one or more choices or selections. The one or more selections may comprise one or more radio buttons, for example, that may be easily selected by the user. In one embodiment, the portable computing device may utter the i^{th} information request and/or the one or more selections or choices to the user. At step 640, in response to one or more commands and/or data provided by the server, the portable computing device may display the i^{th} item description and its corresponding i^{th} user editable field in the second display area. At step 644, the portable computing device may provide a displayable keyboard or keypad to the user by which the user may input data. The appropriate keyboard may be automatically generated in a third display area and may provide an appropriate character set required for a user to answer the i^{th} information request. The keyboard or keypad may be displayed in response to one or more commands and data received from the server. In one embodiment, the keyboard may comprise a touch sensitive or touch screen keypad displayed over a third display area. In one embodiment, the third display area may be automatically displayed when a cursor is placed within the i^{th} answer field. In another embodiment, the keyboard may comprise a physical keyboard of the portable computing device. Thereafter, at step 648, the portable computing device may receive data corresponding to the i^{th} answer of the i^{th} information request.

In one embodiment, the answer may be received when the user utters words captured by a microphone. The received audio may be processed by way of a voice recognition algorithm executed by a processor in the portable computing device. In one embodiment, the user may provide one or more gestures to an integrated camera of the portable computing device. The one or more gestures may be used to indicate a selection of one or more selections. The one or more gestures may comprise one or more movements performed by the user, such as hand or fingertip signs, signals, and/or motions. The received video may be processed by way of a gesture recognition algorithm executed by a processor of the portable computing device and/or the processor of the server. In one embodiment, the portable computing device may assist the user by way of an auto-complete mechanism, allowing the user to select a desired word or phrase as the user types. Thereafter, at step 652, the user may indicate that the i^{th} answer has been fully entered or submitted. In response to receiving an indication from the user that the answer has been fully entered or submitted, the server and/or portable computing device may automatically refresh the user editable field located in the second display area to reflect the answer provided by the user for the i^{th} answer field. In one embodiment, the server may transmit one or more commands and/or data to the portable computing device to facilitate or cause the second display area to refresh the user editable field and display the answer provided by the user. The processor or processing module in the portable computing device may use the commands and/or data received from the server to generate and display the answer input by the user in the i^{th} answer field. The user may view the contents of any user editable field of the user fillable document by way of scrolling to the desired user editable field in the user fillable document. The user may edit any user editable field if there is a need to do so. Thereafter, the process proceeds with step 656 where a decision is made whether the i^{th} information request comprises the last information request. If the i^{th} information request corresponds to the last information request in the user fillable document, the process continues at step 664. Otherwise, the process continues at step 660 where the count variable is incremented by one. Thereafter, the process reverts back to step 612. At step 664, the portable computing device may display the entire completed user fillable document to the user. The entire user fillable document may be displayed and/or resized as a function of the screen size of the portable computing device in response to one or more inputs provided by the user. Next, at step 668, the server and/or portable computing device may correlate and/or verify each of the one or more answers provided by the user with data obtained from other sources and/or databases, including the Internet.

If the correlation and/or verification determine that an answer provided by the user is not consistent with what is found from the other sources and/or databases, further verification and/or confirmation may be needed. An answer may be correlated with one or more databases and the outcome of the correlation may comprise a value. At step 672, a decision may be made whether further verification is needed based on the outcome of the correlation and/or verification. When the outcome comprises a value, further verification may be performed if the value falls below a particular confidence level. If it is determined that further verification is required based on the value, the server and/or portable computing device, at step 676, may generate one or more clarifying information requests to the user in an attempt to confirm an answer received by the user. The one or more clarifying information requests may be presented to the user in the first display area, for example. The one or more clarifying information requests may comprise one or more questions that confirm the i^{th} answer. The server may transmit one or more commands and/or data to the portable computing device to facilitate or cause the clarifying information requests to be displayed on the screen of the portable computing device. Thereafter, at step 680, the portable computing device may receive a revised answer from the user in response to the one or more clarifying information requests. Thereafter, at step 684, after each of the answers provided by the user has been correlated and verified, the server and/or portable computing device may display the finalized version of the user fillable document to the user and store the finalized version of the user fillable document into a database. The database and the user fillable document may be stored in the server and/or the portable computing device. The server may be owned and operated by a company associated with the user fillable document.

The various aspects described herein may be embodied as a method, a system or apparatus, one or more computing devices, servers, and/or computer systems, and/or a computer-readable storage media for storing software or a computer program comprising computer-executable instructions (or instructional code) that are capable of being executed by at least one processor or processing module resident in the one or more portable computing devices, servers, and/or computer systems. The computer-readable storage media may comprise any type of storage media or memory such as a USB drive, hard disk drive, optical disk, and/or flash memory, for example. Accordingly, these aspects may take the form of an entirely hardware embodiment, an entirely software embodiment, or an embodiment combining software and hardware aspects.

While aspects of the disclosure have been described in terms of illustrative embodiments thereof, it will be understood by those skilled in the art that the disclosure is not limited to these embodiments. It is contemplated that the embodiments described herein are susceptible to many modifications of form, arrangement, of parts, details and order of operation and that there are numerous other embodiments, modifications, and variations of the disclosure that fall within the scope and spirit of the disclosure from a review of this entire disclosure. Furthermore, for example, the one or more steps illustrated in the illustrative figures may be performed in other than the recited order, and that the one or more steps illustrated may be optional in accordance with the various aspects of the disclosure. While some embodiments have been described with respect to specific examples, other embodiments include numerous variations and permutations of the above described systems and techniques.

Although the subject matter has been described in language specific to structural features and/or methodological acts, it is to be understood that the subject matter defined in the appended claims is not necessarily limited to the specific embodiments and/or features described above. Rather, the specific embodiments and/or features described above are disclosed as illustrative forms of implementing the claims that follow.

1. A computing device for filling out a user fillable document comprising:
at least one processor; and
at least one memory storing executable instructions that, when executed by said at least one processor, cause said computing device to:
display an information request associated with an item description in said user fillable document, said information request and an answer field displayed in a first display area of said computing device;
display a portion of said user fillable document in a second display area of said computing device, wherein said portion comprises:
said item description, and
a user editable field; and
in response to receiving an answer by said answer field, display said answer in said user editable field of said second display area.

2. The computing device of claim 1 wherein said executable instructions are downloaded by said computing device from a digital distribution platform.

3. The computing device of claim 1 wherein executing said executable instructions further cause said computing device to:
locate said item description in said user fillable document;
identify text associated with said item description; and
process said text to formulate said information request.

4. The computing device of claim 1 wherein said answer is received by way of receiving a selection from two or more choices, said two or more choices displayed in said first display area.

5. The computing device of claim 1 wherein executing said executable instructions further cause said computing device to:
receive an indication that said answer has been submitted; and
wherein said displaying said answer in said second display area occurs when said indication has been received.

6. The computing device of claim 1 wherein said answer is correlated with a database and a decision is made whether to generate a clarifying information request to confirm said answer.

7. The computing device of claim 1 wherein said second display area is scrollable to provide viewing of another portion of said user fillable document.

8. The computing device of claim 1 wherein said answer is correlated with data obtained from the Internet to generate an outcome and wherein a decision is made based on said outcome to determine whether to generate a clarifying information request to verify said answer.

9. The computing device of claim 1 wherein said user editable field is automatically populated based on one or more previously received answers corresponding to one or more previously generated information requests.

10. The computing device of claim 9 wherein said automatically populating is further based on correlating said one or more previously received answers with a database.

11. The computing device of claim 10 wherein said database is located in one of:
a) said computing device and b) a server communicatively coupled to said computing device.

12. The computing device of claim 1 wherein said answer is generated by way of using a touch-sensitive keyboard of said computing device, said touch-sensitive keyboard displayed in a third display area of said computing device.

13. The computing device of claim 1 wherein said answer is received by way of an audio signal captured by a microphone of said computing device and wherein said at least one processor processes said audio signal by way of a voice recognition algorithm.

14. The computing device of claim 1 wherein said second display area is automatically adjusted to include only said item description and said user editable field in said portion.

15. The computing device of claim 1 wherein said answer is received by way of a gesture captured by said computing device and wherein said at least one processor processes said gesture by way of a gesture recognition algorithm.

16. The portable computing device of claim 12 wherein said first, second, and third display areas are provided by a display device resident within said computing device, said display device comprising a touch-screen.

17. The computing device of claim 1 wherein said computing device comprises a wireless computing device.

18. The computing device of claim 1 wherein said computing device comprises a wired computing device.

19. The computing device of claim 17 wherein said wireless computing device comprises a phone.

20. A method for filling out a user fillable document comprising:
displaying an information request associated with an item description of said user fillable document, said information request and an answer field displayed in a first display area of a computing device;
displaying a portion of said user fillable document in a second display area of said computing device, wherein said portion comprises:
said item description, and
a user editable field;
in response to receiving an answer by said answer field, displaying said answer in said user editable field of said second display area; and
wherein said displaying and receiving are performed by a processing module of said computing device.

21. The method of claim 20 wherein said processing module executes executable instructions downloaded by said computing device from a digital distribution platform.

22. The method of claim 20 further comprising:
locating said item description in said user fillable document;
identifying text associated with said item description; and
processing said text to formulate said information request.

23. The method of claim 20 wherein said answer is received by way of a selection from two or more choices, said two or more choices displayed in said first display area.

24. The method of claim 20 wherein said processing module further causes said computing device to:
receive an indication that said answer has been submitted; and
wherein said displaying said answer in said user editable field of said of said second display area occurs when said indication has been received.

25. The method of claim 20 wherein said answer is correlated with a database and a decision is made whether to generate a clarifying information request to confirm said answer.

26. The method of claim 20 wherein said second display area is scrollable to provide viewing of another portion of said user fillable document.

27. The method of claim 20 wherein said answer is correlated with data obtained from the Internet to generate an outcome and wherein a decision is made based on said outcome to determine whether to generate a clarifying information request to verify said answer.

28. The method of claim 20 wherein said user editable field is automatically populated based on one or more previously received answers corresponding to one or more previously generated information requests.

29. The method of claim 28 wherein said automatically populating is further based on correlating said one or more previously received answers with a database.

30. The method of claim 29 wherein said database is located in one of: a) said computing device and b) a server communicatively coupled to said computing device.

31. The method of claim 20 wherein said answer is generated by way of using a touch-sensitive keyboard of said computing device, said touch-sensitive keyboard displayed in a third display area of said computing device.

32. The method of claim 20 wherein said answer is received by way of an audio signal captured by a microphone of said computing device and wherein said processing module processes said audio signal by way of a voice recognition algorithm.

33. The method of claim 20 wherein said second display area is automatically adjusted to include only said item description and said user editable field in said portion.

34. The method of claim 20 wherein said answer is received by way of a gesture captured by said computing device and wherein said processing module processes said gesture by way of a gesture recognition algorithm.

35. The method of claim 31 wherein said first, second, and third display areas are provided by a display device resident within said computing device, said display device comprising a touch-screen.

36. The method of claim 20 wherein said computing device comprises a wireless computing device.

37. The method of claim 20 wherein said computing device comprises a wired computing device.

38. The method of claim 36 wherein said wireless computing device comprises a phone.

39. The method of claim 20 wherein said displaying said answer in said user editable field of said second display area is performed in response to signals received from a server.

40. A server for facilitating the completion of a form electronically by a computing device comprising:
at least one processor; and
at least one memory storing computer executable instructions that, when executed by said at least one processor, cause said server to transmit one or more signals to said computing device to cause said computing device to:
display an information request associated with an item description of a user fillable document, said information request and an answer field displayed in a first display area of said computing device;
display a portion of said user fillable document in a second display area of said computing device, wherein said portion comprises:
said item description, and
a user editable field; and
in response to receiving an answer by said answer field, display said answer in said user editable field of said second display area.

41. The server of claim 40 wherein executing said executable instructions further cause said server to:
locate said item description in said user fillable document;
identify text associated with said item description; and
process said text to formulate said information request.

42. The server of claim 40 wherein said answer is received by way of receiving a selection from two or more choices, said two or more choices displayed in said first display area.

43. The server of claim 40 wherein executing said computer executable instructions further cause said server to transmit said signals to said computing device to cause said computing device to display said answer in said second display area when an indication has been received by said server that said answer has been submitted.

44. The server of claim 40 wherein said answer is correlated with a database and a decision is made whether to generate a clarifying information request to confirm said answer.

45. The server of claim 40 wherein said second display area is scrollable to provide viewing of another portion of said user fillable document.

46. The server of claim 40 wherein said answer is correlated with data obtained from the Internet to generate an outcome and wherein a decision is made based on said outcome to determine whether to generate a clarifying information request to verify said answer.

47. The server of claim 40 wherein said user editable field is automatically populated based on one or more previously received answers corresponding to one or more previously generated information requests.

48. The server of claim 47 wherein said automatically populating is further based on correlating said one or more previously received answers with a database.

49. The server of claim 48 wherein said database is located in one of: a) said computing device and b) a server communicatively coupled to said computing device.

50. The server of claim 40 wherein said answer is generated by way of using a touch-sensitive keyboard of said computing device, said touch-sensitive keyboard displayed in a third display area of said computing device.

51. The server of claim 40 wherein said answer is received by way of an audio signal captured by a microphone of said computing device and wherein a processor of said computing device and/or said at least one processor of said server processes said audio signal by way of a voice recognition algorithm.

52. The server of claim 40 wherein said second display area is automatically adjusted to include only said item description and said user editable field in said portion.

53. The server of claim 40 wherein text displayed by said user editable field is editable.

54. The server of claim 40 wherein said answer is received by way of a gesture captured by said computing device and wherein a processor of said computing device processes said gesture by way of a gesture recognition algorithm.

55. The server of claim 50 wherein said first, second, and third display areas are provided by a display device resident within said computing device, said display device comprising a touch-screen.

56. The server of claim 40 wherein said computing device comprises a wireless computing device.

57. The server of claim 40 wherein said computing device comprises a wired computing device.

58. The server of claim 56 wherein said wireless computing device comprises a phone.

59. A non-transitory computer readable storage media having stored thereon, a software program having at least one code section for processing data, said at least one code section executable by at least one processor of a computing device for causing said computing device to:
display an information request associated with an item description of a user fillable document, said information request and an answer field displayed in a first display area of said computing device;
display a portion of said user fillable document in a second display area of said computing device, wherein said portion comprises:
said item description, and
a user editable field; and
in response to receiving an answer by said answer field, display said answer in said user editable field of said second display area; and
store said answer into a file associated with said user fillable document.

60. A non-transitory computer readable storage media having stored thereon, a software program having at least one code section for processing data, said at least one code section executable by at least one processor of a server for causing said server to:
transmit one or more signals to a computing device to cause said computing device to:
display an information request associated with an item description of a user fillable document, said information request and an answer field displayed in a first display area of a computing device;
display a portion of said user fillable document in a second display area of said computing device, wherein said portion comprises:
said item description, and
a user editable field; and
in response to receiving an answer by said answer field, display said answer in said user editable field of said second display area; and
store said answer into a file associated with said user fillable document.
